(19) United States
(12) Patent Application Publication
(10) Pub. No.: US 2021/0102299 A1
(43) Pub. Date: Apr. 8, 2021

(54) MULTIFUNCTIONAL SURFACTANT AND CORROSION INHIBITOR ADDITIVES

(71) Applicant: Multi-Chem Group, LLC, Houston, TX (US)

(72) Inventors: Stephen John Horner, Needville, TX (US); Chad Eldon Kiser, Santa Fe, TX (US)

(21) Appl. No.: 16/596,065

(22) Filed: Oct. 8, 2019

(51) Int. Cl. C23F 11/16

(52) U.S. Cl. CPC C23F 11/16; C09K 8/54

(57) ABSTRACT

Multifunctional surfactants useful in, for example, in the oil and gas industry, are provided. In some embodiments, the multifunctional surfactants include at least one amide group and at least one thiol group in the same molecule. In some embodiments, the methods include contacting a metal surface with at least one multifunctional additive that includes at least one amide group and at least one thiol group in the same molecule; and allowing the multifunctional additive to interact with at least a portion of the metal surface.

### BACKGROUND

The present disclosure relates to the use and manufacture of surfactants and corrosion inhibitors in certain applications.

The corrosion of metal surfaces may occur when metal surfaces are contacted by a corrosive environment containing an oxidizer (e.g., an electrochemical oxidizer, a chemical oxidizer or the like). Illustrative corrosive environments include, for example, acidic environments, environments containing water vapor in the presence of air and/or oxygen, and environments containing chloride or bromide ions, carbon dioxide and/or hydrogen sulfide. As used herein, the term “corrosion” refers to any interaction between a material and its environment that causes some deterioration of the material or its properties. Examples of common types of corrosion include, but are not limited to, the rusting of a metal, the dissolution of a metal in acids, and patina development on the surface of a metal.

In the oil and gas industry applications, metal surfaces on various types of equipment are often exposed to corrosive conditions during surface and downhole operations. For example, surface equipment used in oil and gas operations and pipelines and conduits used to transport fluids between various locations (in the oilfield industry and elsewhere) may be exposed to fluids that can cause corrosion. Corrosive components including brine, carbon dioxide, and/or hydrogen sulfide are also commonly encountered downhole. Corrosive environments can be produced by treatment fluids that are commonly used in a number of operations in the oil and chemical industries. In such operations, any metal surfaces present (e.g., piping, tubular goods, heat exchangers and reactors) are subjected to the corrosive environment of the treatment fluid.

To combat potential corrosion problems, certain corrosion inhibitors additives have been used to reduce, inhibit, and/or substantially prevent corrosion of metal and metal alloy surfaces on downhole equipment, all with varying levels of success. As used herein, the term “inhibit” and its derivatives refer to a lessening of the tendency of a phenomenon to occur and/or the degree to which that phenomenon occurs. The term “inhibit” does not imply any particular degree or amount of inhibition.

Surfactants may be used for a number of purposes in refinery, pipeline, and subterranean operations, for example, as emulsifying agents, non-emulsifying agents, foaming agents, defoaming agents, viscosifying (e.g., gelling) agents, dispersants, wetting agents, and the like. Surfactants also may be used to provide other benefits such as wax control, antifouling, asphaltene control, anti-agglomeration, hydrate control, scale control, changing the wettability of surfaces, solubilizing certain materials, dewatering fluids, reducing the surface tension of fluids, and the like. Surfactants, as that term is used herein, are thought of as surface-active agents, that are usually organic and whose molecules contain a hydrophilic group at one end and a lipophilic group at the other. Surfactants often act as wetting agents that are capable of reducing the surface tension of a liquid in which it is dissolved.

### BRIEF DESCRIPTION OF THE DRAWINGS

These drawings illustrate certain aspects of some of the embodiments of the present disclosure, and should not be used to limit or define the claims.

FIG. 1 is a diagram illustrating an injection system used in accordance with certain embodiments of the present disclosure.

FIG. 2 is a graph of data from corrosion inhibition testing of certain multifunctional additives of the present disclosure and commercially-available corrosion inhibitors.

FIG. 3 is a graph of data from additional corrosion inhibition testing of certain multifunctional additives of the present disclosure and commercially-available corrosion inhibitors.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure involving wellbores may be applicable to horizontal, vertical, deviated, or otherwise nonlinear wellbores in any type of subterranean formation. Embodiments may be applicable to injection wells, monitoring wells, and production wells, including hydrocarbon or geothermal wells.

As used herein, the nomenclature “Cₓ to C_{y}” refers to the number of carbon atoms in a hydrocarbyl group (here, ranging from x to y carbon atoms), wherein x and y may be any positive integer. As used herein, a “hydrocarbyl group” may, unless otherwise specifically noted, be branched, unbranched, non-cyclic, and/or cyclic; substituted or unsubstituted (that is, it may or may not contain one or more additional moieties or functional groups in place of one or more hydrogen atoms in the hydrocarbon chain); saturated or unsaturated; and/or may include one or more heteroatoms (e.g., O, N, P, S). As used herein, “independently” refers to the notion that preceding items may be the same as or different from each other.

The present disclosure relates to the use and manufacture of surfactants and corrosion inhibitors in certain applications. More particularly, the present disclosure relates to the manufacture and use of multifunctional surfactants, for example, in the oil and gas industry.

The present disclosure provides methods of manufacturing and using certain multifunctional additives, each molecule of which includes at least one amide group and at least one thiol group. In some embodiments, the multifunctional additives of the present disclosure may both function as a surfactant and inhibit corrosion of metal surfaces in a particular application. For example, the multifunctional additives of the present disclosure may inhibit and/or reduce corrosion in acidic environments, environments containing water vapor in the presence of air and/or oxygen, and environments containing chloride or bromide ions, carbon dioxide, and/or hydrogen sulfide. In certain embodiments, the multifunctional additives may inhibit corrosion of various types of metals, including, but not limited to a ferrous alloy, carbon steel, copper, aluminum, any derivative thereof, and any combination thereof. In some embodiments, the multifunctional additives of the present disclosure may provide numerous different surface-active functionalities, including wax control, antifouling, asphaltene control, anti-agglomeration, hydrate control, scale control, etc. Thus, in some embodiments, additional surfactants and/or corrosion inhibitors may not be present or necessary (either in significant amounts or at all) in fluids and or other environments treated using the multifunctional additives of the present disclosure. Various formulations of the multifunctional additives of the present disclosure may be used in any number of applications, including but not limited to upstream, midstream, and downstream applications in the oil and gas industry such as refining operations, pipeline operations, and in well bores, treatment fluids, and/or equipment (e.g., production equipment, downhole equipment, and the like, as well as components thereof) used in wellsite operations.

Among the many potential advantages to the methods and compositions of the present disclosure, only some of which are alluded to herein, the methods and compositions of the present disclosure may reduce the cost and/or complexity of a treatment fluid by reducing the number of additives needed to provide the desired functionalities such as surface-active properties and/or reduced corrosion. In some embodiments, the compositions and multifunctional additives of the present disclosure may be more versatile than other surfactants and/or corrosion inhibiting additives in that the same additive may be effective in multiple different types of environment with different conditions, such as those found in refining, pipeline, and/or subterranean applications. Without limiting the disclosure to any particular mechanism, in some embodiments, the molecules of the multifunctional additives of the present disclosure may form a thin film, e.g., that may include a monolayer of the additive's molecules along a metal surface formed via interactions of the thiol group with the metal surface and/or hydrogen bonding between the amide groups of the additive molecules. This monolayer or other thin film may, among other benefits, interrupt the electrochemical reaction of corrosion in various ways, including displacement of, or creating a barrier to, water contact with the metal surface. While metal surfaces may appear to be uniform at the macro level, they have a number of variations at the micro level. For example, carbon steels may have higher or lower levels of carbon as compared to levels of iron at the surface or may have different polarity in different locations within the same piece of metal. These differences create multiple environments on which the multifunctional additives of the present disclosure may create films of various structures.

The multifunctional additives of the present disclosure generally include at least one amide group and at least one thiol group in the same molecule. For example, such molecules may have the following general structure:

HS—R¹—CONH—R²

wherein R¹ and R² are independently selected as any alkyl group (e.g., a C₁-C₃₀ group). Examples of a multifunctional additives of the present disclosure may include, but are not limited to, N-dodecyl-2-mercaptoacetamide (DDMA) (CAS 32358-33-1), N-coco-2-mercaptoacetamide, N-coco-2-mercaptopropanamide, and the like. Any compound or compounds having at least one amide group and at least one thiol group in the same molecule, for example, having this general structure may be used. In some embodiments, the multifunctional additive may be provided as one or more salts of any of the foregoing molecules or portions thereof. In some embodiments, the molecules of the multifunctional additive may include multiple thiol and/or amide groups (e.g., polyamides), as well as additional functional groups.

The multifunctional additives of the present disclosure may be synthesized using any known means, for example, using processes similar to amide condensation reactions. In some embodiments, one or more catalysts may be used to drive the amide condensation reaction. These processes may use starting materials that include one or more amines and one or more thio-acids. The amines may be any refined or unrefined amines, including single-chain amines (e.g., C₈-C₃₀ primary amines), polyamines, diamines, natural amine mixtures (e.g., cocoamine, tallow amine, lauryl amine, soya amine, etc.), or any derivative or combination thereof. The thio-acids may be any sulfur-containing organic acid, such as C₂-C₁₂ thio-acids. Examples of thio-acids may include, but are not limited to, thioglycolic acid, thiopropionic acid, thiobutyric acid, and any derivative or combination thereof. The selection of particular amines and/or thio-acids may be varied to produce the desired molecules.

The multifunctional additives of the present disclosure may be included in a treatment fluid and/or other environment in any suitable concentration. For example, one or more multifunctional additives of the present disclosure may be introduced into and/or present in a fluid in an amount within a range of from about 1 part per million (ppm) to about 10,000 ppm by volume based on the volume of the fluid. In various embodiments, an effective amount of one or more multifunctional additives of the present disclosure may be as low as any of: 1 ppm, 3 ppm, 6 ppm, 9 ppm, 15 ppm, 20 ppm, 25 ppm, 30 ppm, 40 ppm, 50 ppm, 75 ppm, or 100 ppm based on the volume of the fluid. In certain embodiments, an effective amount of one or more multifunctional additives of the present disclosure in a fluid may be as high as any of: 10 ppm, 25 ppm, 50 ppm, 75 ppm, 100 ppm, 125 ppm, 150 ppm, 175 ppm, 200 ppm, 225 ppm, 250 ppm, 275 ppm, 300 ppm, 325 ppm, 350 ppm, 375 ppm, 400 ppm, 425 ppm, 450 ppm, 475 ppm, 500 ppm, 1000 ppm, or 10,000 ppm based on the volume of the fluid. Thus, in one or more embodiments, an effective amount of one or more multifunctional additives for inhibiting, retarding, mitigating, reducing, controlling, and/or delaying corrosion may be within a range of from about 1 ppm to about 1000 ppm by volume based on the volume of the fluid; from about 1 ppm to about 500 ppm by volume based on the volume of the fluid; from about 1 ppm to about 300 ppm by volume based on the volume of the fluid; from about 1 ppm to about 100 ppm by volume based on the volume of the fluid; from about 3 ppm to about 50 ppm by volume based on the volume of the fluid; from about 3 ppm to about 25 ppm by volume based on the volume of the fluid; or from about 6 ppm to about 15 ppm by volume based on the volume of the fluid.

In some embodiments, a multifunctional additive of the present disclosure optionally may be provided in or with, or formulated to include, one or more solvents, which may be oil-soluble or water-soluble solvents. Examples of solvents suitable for certain embodiments of the present disclosure include, but are not limited to water, alcohols (e.g., methanol, isopropyl alcohol, glycol, ethylene glycol), organic solvents (e.g., toluene, xylene, monobutyl ether, hexane, cyclohexane), and any combination or derivative thereof, for example. In certain embodiments, the multifunctional additives of the present disclosure may be used with substantially no solvent, e.g., in an absence of a significant amount of solvent.

In some embodiments, a multifunctional additive of the present disclosure optionally may be provided in or with, or formulated to include, one or more rheology modifiers, among other reasons, to modify the rheology of the multifunctional additives, for example, to adjust the viscosity of the multifunctional additives, to adjust the freezing point of the multifunctional additives, to facilitate handling of the multifunctional additives, to facilitate transport of the multifunctional additives, to facilitate pumping of the multifunctional additives, to facilitate precise dosing of the multifunctional additives, and/or to control the application rate of the multifunctional additives, and the like. In some embodiments, the rheology modifier may include low viscosity liquids that are miscible or dispersible in a particular multifunctional additive of the present disclosure. Rheology modifiers suitable for certain embodiments of the present disclosure include, but are not limited to C₁ to C₁₀ alcohols (e.g., methanol, ethanol, isopropyl alcohol, butanol, 2-ethoxyethanol, ethylene glycol, propylene glycol), acetates such as carboxylate esters (e.g., methyl acetate, ethyl acetate, isopropyl acetate, 2 ethylhexyl acetate), and ketones such as alkyl aldehyde (e.g., acetone, methyl ethyl ketone, dimethylformamide).

In some embodiments, the multifunctional additive(s) of the present disclosure may be incorporated into a fluid. For example, in some embodiments, the multifunctional additive may be added to a treatment fluid for use in a wellbore penetrating a subterranean formation during, for instance, oil and/or gas recovery operations. The treatment fluids used in the methods and systems of the present disclosure may include any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may include water from any source. Such aqueous fluids may include fresh water, salt water (e.g., water containing one or more salts dissolved therein), brine (e.g., saturated salt water), seawater, or any combination thereof. In most embodiments of the present disclosure, the aqueous fluids include one or more ionic species, such as those formed by salts dissolved in water. For example, seawater and/or produced water may include a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons, organic liquids, and the like. In certain embodiments, the fracturing fluids may include a mixture of one or more fluids and/or gases, including but not limited to emulsions, foams, and the like.

In certain embodiments, the multifunctional additives and/or treatment fluids used in the methods and systems of the present disclosure optionally may include any number of additional components. Examples of such additional components include, but are not limited to, salts, additional surfactants, acids, proppant particulates, diverting agents, fluid loss control additives, gas, nitrogen, carbon dioxide, surface modifying agents, tackifying agents, foamers, additional corrosion inhibitors, scale inhibitors, catalysts, clay control agents, biocides, friction reducers, antifoam agents, bridging agents, flocculants, H₂S scavengers, CO₂ scavengers, oxygen scavengers, lubricants, viscosifiers, breakers, weighting agents, relative permeability modifiers, resins, wetting agents, coating enhancement agents, filter cake removal agents, antifreeze agents (e.g., ethylene glycol), and the like. A person skilled in the art, with the benefit of this disclosure, will recognize the types of optional components that may be included in the fluids of the present disclosure for a particular application.

The methods and compositions of the present disclosure may be used during or in conjunction with any subterranean operation. Suitable subterranean operations may include, but are not limited to, preflush treatments, afterflush treatments, drilling operations, hydraulic fracturing treatments, sand control treatments (e.g., gravel packing), acidizing treatments (e.g., matrix acidizing or fracture acidizing), “frac-pack” treatments, well bore clean-out treatments, and other operations where a surfactant and/or corrosion-inhibiting additive may be useful. In certain embodiments, the multifunctional additives may be used in near wellbore clean-out operations, wherein a treatment fluid that carries the multifunctional additive may be circulated in the subterranean formation, thereby suspending or solubilizing particulates residing in the formation. The treatment fluid then may be recovered out of the formation, carrying the suspended or solubilized particulates with it. In certain embodiments, the methods and/or compositions of the present disclosure may be used in construction and/or operation of pipelines (e.g., transportation pipelines, distribution pipelines, etc.) or umbilical equipment that may be used, among other purposes, to transport various fluids (e.g., treatment fluids and/or fluids produced from subterranean formations). In certain embodiments, the methods and/or compositions of the present disclosure may be used in refining operations and/or refinery equipment used to treat oil and other fluids produced from subterranean formations.

In certain embodiments, a fluid including the multifunctional additive of the present disclosure may be flowing or it may be substantially stationary. In certain embodiments, the fluid may be within a vessel, within a conduit (e.g., a conduit that may transport the fluid), within a subterranean formation, within a wellbore penetrating a portion of the subterranean formation, and/or within a wellhead of a wellbore. Examples of conduits suitable for certain embodiments include, but are not limited to pipelines, production piping, subsea tubulars, process equipment, and the like as used in industrial settings and/or as used in the production of oil and/or gas from a subterranean formation, and the like. In particular embodiments, the conduit may be a wellhead, a wellbore, or may be located within a wellbore penetrating at least a portion of a subterranean formation. Such oil and/or gas well may, for example, be a subsea well (e.g., with the subterranean formation being located below the sea floor), or it may be a surface well (e.g., with the subterranean formation being located belowground). A vessel or conduit according to other embodiments may be located in an industrial setting such as a refinery (e.g., separation vessels, dehydration units, pipelines, heat exchangers, and the like), or may be a transportation pipeline.

In certain embodiments, the multifunctional additives may be introduced into a wellhead of a wellbore penetrating at least a portion of the subterranean formation, a wellbore, a subterranean formation, a vessel, and/or a conduit (and/or into a fluid within any of the foregoing) using any method or equipment known in the art. In certain embodiments, the multifunctional additive is introduced into a wellbore penetrating at least a portion of a subterranean formation through which a fluid is flowing. For example, the multifunctional additive may be applied to a subterranean formation and/or wellbore using batch treatments, squeeze treatments, continuous treatments, and/or any combination thereof. In certain embodiments, a batch treatment may be performed in a subterranean formation by stopping production from the well and pumping the fluid including the multifunctional additive into a wellbore, which may be performed at one or more points in time during the life of a well. In other embodiments, a squeeze treatment may be performed by dissolving the multifunctional additive in a suitable solvent at a suitable concentration and squeezing that solvent carrying the multifunctional additive downhole into the formation, allowing production out of the formation to bring the multifunctional inhibitor to its desired location.

In other embodiments, the multifunctional additive may be injected into a portion of a subterranean formation using an annular space or capillary injection system to continuously introduce the multifunctional additive into the formation. In certain embodiments, a composition (such as a treatment fluid) including the multifunctional additive may be circulated in the wellbore using the same types of pumping systems and equipment at the surface that are used to introduce treatment fluids or additives into a wellbore penetrating at least a portion of the subterranean formation. In certain embodiments, the multifunctional additive may be introduced to a fluid through a conduit or an injection point in fluid communication with a wellbore in which the fluid resides. In certain embodiments, the fluid is introduced through a conduit through which the fluid is flowing.

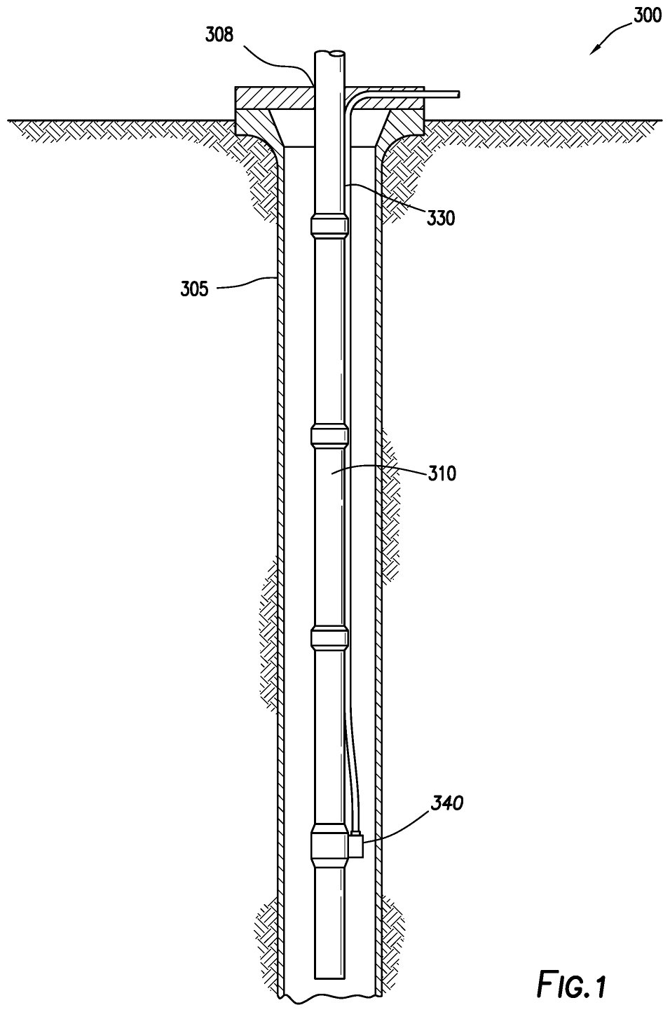

For example, a multifunctional additive of the present disclosure may be introduced into a wellbore and/or tubing using a capillary injection system as shown in FIG. 1. Referring now to FIG. 1, wellbore 305 has been drilled to penetrate a portion of a subterranean formation 300. A tubing 310 (e.g., production tubing) has been placed in the wellbore 305. A capillary injection tube 330 is disposed in the annular space between the outer surface of tubing 310 and the inner wall of wellbore 305. The capillary injection tube 330 is connected to a side-pocket mandrel 340 at a lower section of the tubing 310. A multifunctional additive may be injected into capillary injection tube 330 at the wellhead 308 at the surface such that it mixes with production fluid at or near the side-pocket mandrel 340. As the production fluid flows through the tubing 310, the multifunctional additive may prevent, inhibit, retard, reduce, control, and/or delay corrosion within the tubing 310. Other capillary injection systems and side pocket mandrel devices (e.g., those used in gas lift production) may be used in a similar manner to the system shown in FIG. 1.

In certain embodiments, the multifunctional additive may be added to a conduit such as a pipeline where one or more fluids enter the conduit and/or at one or more other locations along the length of the conduit. In such embodiments, the multifunctional additive may be added in batches or injected substantially continuously while the pipeline is being used, for example, to maintain the concentration of the multifunctional additive in the fluid at a certain amount (e.g., one or more of the concentrations referenced above). Once introduced into a fluid, subterranean formation, wellbore, pipeline, vessel, or other location, the multifunctional additive may inhibit, retard, reduce, control, and/or delay corrosion within the fluid, subterranean formation, wellbore, pipeline, vessel, or other location. In one or more of the applications described above, the multifunctional additive of the present disclosure also may act as a surfactant, for example, to perform additional functions such as wax control, antifouling, asphaltene control, anti-agglomeration, hydrate control, scale control, and the like.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLE

### Synthesis of Multifunctional Additive (N-coco-2-mercaptoacetamide)

A commercially-available coco-amine product (Armeen® CD, available from Nouryon (formerly Akzo Nobel)) and thioglycolic acid in an approximately 1:1 mol ratio (2.15:1 mass ratio) were added to a three neck flask fitted with a Dean-Stark trap and heating mantle thermocouple. Upon initial addition and stirring with a magnetic stir bar, the temperature rose to 92° C. The temperature was slowly increased to 150° C. and held at that temperature for 3 hours. Approximately 3 mL of water was collected at 150° C. The temperature was then increased to 155° C. for 1.5 hours, and an additional 4.5 mL of water was collected. The solution was allowed to cool to room temperature, yielding a white, waxy solid. After sitting at room temperature overnight, the solid was melted in the range 80-105° C. and then heated to 165° C. with no additional water collected. Upon cooling to 100° C. a light yellow liquid was collected. The liquid solidified to a white, waxy solid upon cooling to room temperature.

### Performance Testing

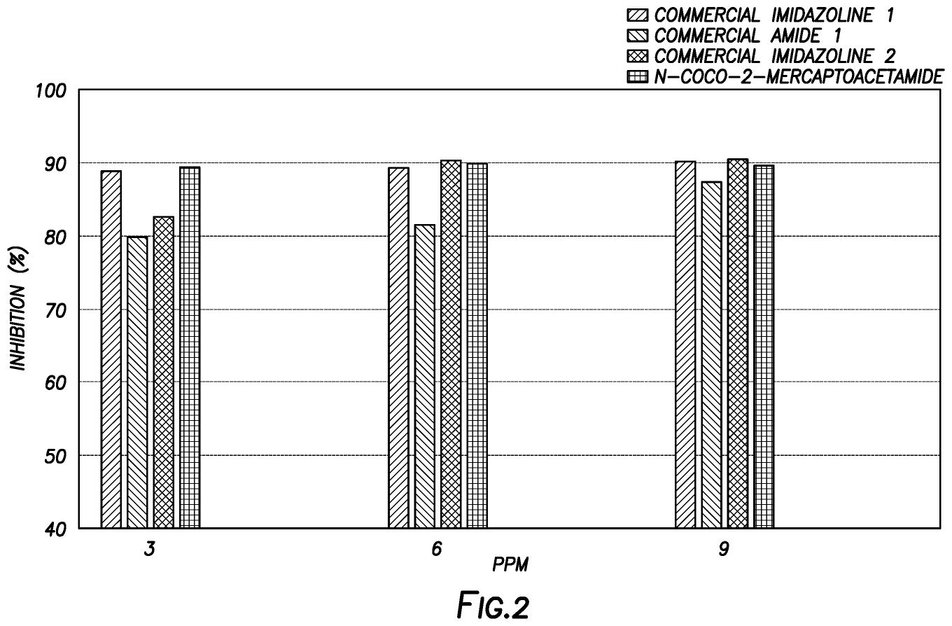

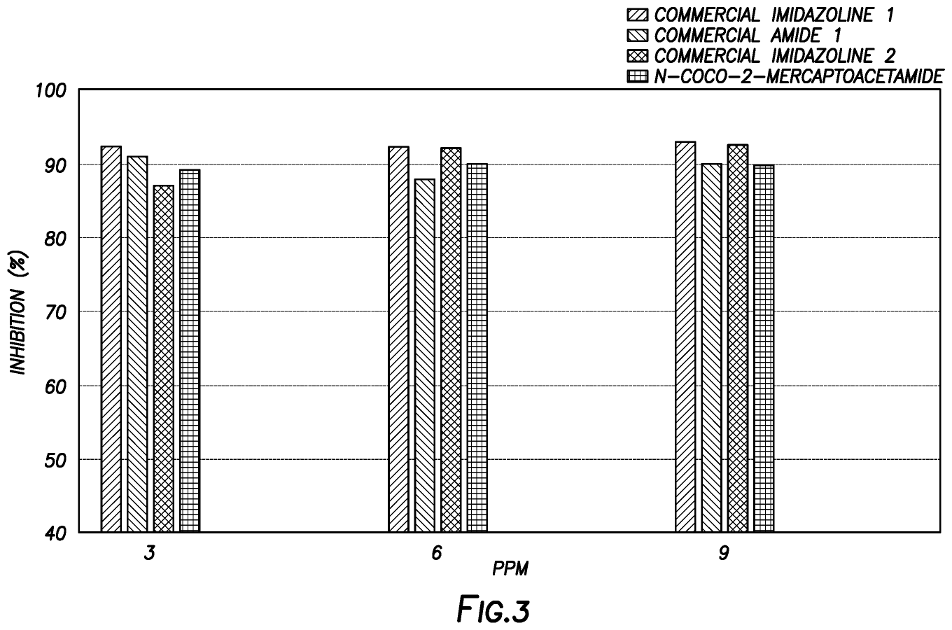

A standard wheel box test was performed to evaluate the corrosion inhibition properties of the N-coco-2-mercaptoacetamide multifunctional additive synthesized in the method above. Sample bottles are filled with 200 ml of the test fluids and a C1080 steel test coupon of a known weight was inserted into the bottle. Two different types of test fluids representing different corrosion environments of interest were studied. The first was a refinery overhead corrosion fluid (OVHD) that included 170 mL of an overhead test brine (used to mimic certain brines collected from refinery overhead systems) and 30 mL of LVT 200 (a light petroleum distillate available from various suppliers), which was then purged with nitrogen gas; the second was a seawater brine purged with carbon dioxide. To each sample bottle was added one of three different inhibitor additives: the N-coco-2-mercaptoacetamide multifunctional additive described above, and 3 different commercially-available imidazoline-based additives from various suppliers. Dosages of 3 ppm, 6 ppm, and 9 ppm of each additive were tested in each type of fluid. Each bottle was then loaded on to a wheel oven and allowed to spin for 24 hours at 176° F. The test coupons were then removed from the bottles, cleaned, re-weighed and percent protection was then calculated. The percent protection/inhibition for the OHVD samples are shown in FIG. 2, and the percent protection/inhibition for the OHVD seawater/CO₂ brine are shown in FIG. 3.

In the OVHD environment (FIG. 2), the N-coco-2-mercaptoacetamide multifunctional additive of the present disclosure performed equivalently to the commercial imidazoline additives and arguably better than the amide in terms of corrosion inhibition. In this environment, the water dispersability of the native molecule may impact the effectiveness of the molecule in inhibiting corrosion. The test results suggests that the N-coco-2-mercaptoacetamide multifunctional additive of the present disclosure may exhibit water dispersability similar to that of imidazoline additives in certain environments.

An embodiment of the present disclosure is a method including: contacting a metal surface with at least one multifunctional additive that includes at least one amide group and at least one thiol group in the same molecule; and allowing the multifunctional additive to interact with at least a portion of the metal surface.

In one or more embodiments described in the preceding paragraph, the multifunctional additive at least partially inhibits corrosion of the metal surface and imparts one or more surface-active properties to the metal surface. In one or more embodiments described above, the metal surface includes a portion of a conduit or vessel in a refinery. In one or more embodiments described above, the metal surface includes a portion of a conduit or vessel in an oil or gas pipeline. In one or more embodiments described above, the multifunctional additive includes at least one compound having the following structure:

HS—R¹—CONH—R²

wherein R¹ and R² are each a C₁-C₃₀ alkyl group. In one or more embodiments described above, the multifunctional additive includes at least one compound selected from the group consisting of: N-dodecyl-2-mercaptoacetamide; N-coco-2-mercaptoacetamide; N-coco-2-mercaptopropanamide; any derivative thereof and any combination thereof. In one or more embodiments described above, the multifunctional additive includes at least one compound synthesized in part from one or more amines selected from the group consisting of: a C₈-C₃₀ primary amine, a polyamine, a diamine, cocoamine, tallow amine, lauryl amine, soya amine, any derivative thereof, and any combination thereof. In one or more embodiments described above, the multifunctional additive includes at least one compound synthesized in part from one or more thio-acids selected from the group consisting of: thioglycolic acid, thiopropionic acid, thiobutyric acid, any derivative thereof, and any combination thereof. In one or more embodiments described above, the method further includes adding the multifunctional additive to a fluid. In one or more embodiments described above, the fluid is located in a portion of a conduit or vessel in an oil or gas pipeline. In one or more embodiments described above, the fluid is located in a portion of a conduit or vessel in a refinery. In one or more embodiments described above, the fluid is introduced into a portion of a component of production equipment at a well site. In one or more embodiments described above, the multifunctional additive is added to the fluid in an amount of from about 1 ppm to about 10,000 ppm by volume of the fluid. In one or more embodiments described above, the multifunctional additive is added to the fluid in an amount of from about 1 ppm to about 500 ppm by volume of the fluid. In one or more embodiments described above, the multifunctional additive further includes at least one solvent.

Another embodiment of the present disclosure is a method including: introducing at least one multifunctional additive into a fluid, the multifunctional additive including at least one amide group and at least one thiol group in the same molecule; and introducing the fluid into at least one component of production equipment at a well site, the component of production equipment including at least one metal surface; and contacting the metal surface in the production equipment with the multifunctional additive.

In one or more embodiments described in the preceding paragraph, the multifunctional additive at least partially inhibits corrosion of the metal surface and imparts one or more surface-active properties to the metal surface. In one or more embodiments described above, the multifunctional additive includes at least one compound selected from the group consisting of: N-dodecyl-2-mercaptoacetamide; N-coco-2-mercaptoacetamide; N-coco-2-mercaptopropanamide; any derivative thereof and any combination thereof.

Another embodiment of the present disclosure is a method including: introducing at least one multifunctional additive into a well bore penetrating at least a portion of a subterranean formation, the multifunctional additive including at least one amide group and at least one thiol group in the same molecule; and contacting a metal surface in the well bore with the multifunctional additive. In one or more embodiments described above, the multifunctional additive at least partially inhibits corrosion of the metal surface and imparts one or more surface-active properties to the metal surface.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
contacting a metal surface with at least one multifunctional additive that comprises at least one amide group and at least one thiol group in the same molecule; and
allowing the multifunctional additive to interact with at least a portion of the metal surface.

2. The method of claim 1 wherein the multifunctional additive at least partially inhibits corrosion of the metal surface and imparts one or more surface-active properties to the metal surface.

3. The method of claim 1 wherein the metal surface comprises a portion of a conduit or vessel in a refinery.

4. The method of claim 1 wherein the metal surface comprises a portion of a conduit or vessel in an oil or gas pipeline.

5. The method of claim 1 wherein the multifunctional additive comprises at least one compound having the following structure:
HS—R¹—CONH—R²
wherein R¹ and R² are each a C₁-C₃₀ alkyl group.

6. The method of claim 1 wherein the multifunctional additive comprises at least one compound selected from the group consisting of: N-dodecyl-2-mercaptoacetamide; N-coco-2-mercaptoacetamide; N-coco-2-mercaptopropanamide; any derivative thereof and any combination thereof.

7. The method of claim 1 wherein the multifunctional additive comprises at least one compound synthesized in part from one or more amines selected from the group consisting of: a C₈-C₃₀ primary amine, a polyamine, a diamine, cocoamine, tallow amine, lauryl amine, soya amine, any derivative thereof, and any combination thereof.

8. The method of claim 1 wherein the multifunctional additive comprises at least one compound synthesized in part from one or more thio-acids selected from the group consisting of: thioglycolic acid, thiopropionic acid, thiobutyric acid, any derivative thereof, and any combination thereof.

9. The method of claim 1 further comprising adding the multifunctional additive to a fluid.

10. The method of claim 9 wherein the fluid is located in a portion of a conduit or vessel in an oil or gas pipeline.

11. The method of claim 9 wherein the fluid is located in a portion of a conduit or vessel in a refinery.

12. The method of claim 9 wherein the fluid is introduced into a portion of a component of production equipment at a well site.

13. The method of claim 9 wherein the multifunctional additive is added to the fluid in an amount of from about 1 ppm to about 10,000 ppm by volume of the fluid.

14. The method of claim 9 wherein the multifunctional additive is added to the fluid in an amount of from about 1 ppm to about 500 ppm by volume of the fluid.

15. The method of claim 1 wherein the multifunctional additive further comprises at least one solvent.

16. A method comprising:
introducing at least one multifunctional additive into a fluid, the multifunctional additive comprising at least one amide group and at least one thiol group in the same molecule; and
introducing the fluid into at least one component of production equipment at a well site, the component of production equipment comprising at least one metal surface; and
contacting the metal surface in the production equipment with the multifunctional additive.

17. The method of claim 16 wherein the multifunctional additive at least partially inhibits corrosion of the metal surface and imparts one or more surface-active properties to the metal surface.

18. The method of claim 16 wherein the multifunctional additive comprises at least one compound selected from the group consisting of: N-dodecyl-2-mercaptoacetamide; N-coco-2-mercaptoacetamide; N-coco-2-mercaptopropanamide; any derivative thereof; and any combination thereof.

19. A method comprising:
introducing at least one multifunctional additive into a well bore penetrating at least a portion of a subterranean formation, the multifunctional additive comprising at least one amide group and at least one thiol group in the same molecule; and
contacting a metal surface in the well bore with the multifunctional additive.

20. The method of claim 19 wherein the multifunctional additive at least partially inhibits corrosion of the metal surface and imparts one or more surface-active properties to the metal surface.
